(19) United States
(12) Patent Application Publication
(10) Pub. No.: US 2013/0117670 A1
(43) Pub. Date: May 9, 2013

(54) SYSTEM AND METHOD FOR CREATING RECORDINGS ASSOCIATED WITH ELECTRONIC PUBLICATION

(71) Applicant: BARNESANDNOBLE.COM LLC, New York, NY (US)

(72) Inventors: Manish MAHAJAN, San Jose, CA (US); Christopher MEDELLIN, New York, NY (US); Keenan KEELING, Silver Spring, MD (US)

(73) Assignee: BARNESANDNOBLE.COM LLC, New York, NY (US)

(21) Appl. No.: 13/666,551

(22) Filed: Nov. 1, 2012

Related U.S. Application Data
(60) Provisional application No. 61/556,082, filed on Nov. 4, 2011.

(51) Int. Cl. G06F 3/16

(52) U.S. Cl. 715/716

(57) ABSTRACT

A system and method that allows recording and playback of audio in association with an electronic publication such as an electronic book. Many applications that are used to view electronic publications are based on technologies that do not have audio capabilities that allow a user to record audio in connection with the electronic publication. The system and method of the present invention overcomes this deficiency by using the audio capabilities that are native in the operating system running on the electronic device used to display the electronic publication. A socket is established between the user interface application and the operating system. Audio commands are transmitted from the user interface application to the operating system via the socket. The audio commands are executed by the operating system using native operating system commands. A message regarding the execution of the audio commands by operating system are sent to the user interface application via the socket.

### FIELD OF THE INVENTION

The present invention generally relates to devices for reading digital content, and more particularly to systems and methods that allow recording audio in association with digital publications.

### BACKGROUND OF THE INVENTION

Systems and methods are known for recording and playing back audio associated with electronic publications. Some of these systems are designed as Flash™ applications for execution on the Android™ operating system. Unfortunately, Flash™ applications are not well-suited for processing audio content (e.g., audio recording, audio playback, etc). In contrast, the Android operating system itself contains various resources that efficiently process audio content. There is a need for a system and method that permit a native Flash™ application to utilize the resources of the Android™ operating system to process audio content associated with electronic publications.

### SUMMARY OF THE INVENTION

Embodiments of the present invention provide the ability to record up to 10 different audio versions of each page or spread (e.g., a collection of two or more pages) of an electronic publication, e.g., an electronic book. A smooth flowing user interface is also provided to enable easy and efficient access to record, playback, and edit functions.

Embodiments of the present invention also provide the ability to synchronize recordings made by users with remote servers, e.g., the “cloud,” and with other devices employing other operating systems. This synchronization capability allows users to play audio content that was originally recorded on another device and vice versa.

Other embodiments of the present invention provide character and scene based recording and playback. Recordings may be tied to graphic images, representing characters, on the particular spread, with each character having unique user generated content (“UGC”). For example, with respect to a particular electronic children's book involving an elephant and crocodile, a child's grandmother can record audio narration associated with the elephant's dialog contained in the book, while the child's grandfather can record narration for the crocodile's dialogue. In a preferred embodiment, there are recording user interfaces (“UI”) and modes that allow character touch based recording. For example, touching the elephant while in a recording mode may permit narration to be recorded for the elephant's dialogue. A user can playback all UGC by a particular character or re-edit UGC on a per character basis. These aspects of the present invention may also be applied to dialog without explicit graphic characters, e.g., conversations in a non-picture book.

Other embodiments of the present invention provide bimodal feedback and learning associated with the UGC, such as bimodal feedback to help a user learn to read. For example, an embodiment may highlight the text of an electronic publication being viewed by the user as the previously recorded audio content associated with that text is played. Providing such highlights may be performed on post processed content that plays as a MP3 or AAC file while the user is viewing a particular spread or page. This can be achieved, for example, by employing speech-to-text technology, which provides appropriate timing information associated with the UGC speech of a particular spread or page. This timing information may then be used to highlight the appropriate text, when the user plays a UGC recording associated with the particular spread or page.

Theme based background audio playback and recording back-drop are also provided by certain embodiments of the present invention to enhance the experience of reading electronic publications. In accordance with a user's choice, themed music associated with particular content of an electronic publication may be played in the background (e.g., low volume horror themed music for a horror novel) while a user reads the content of the publication and/or while UGC is being played back. Audio themes can also be used as a backdrop while recording UGC audio. For example, rain or thunderstorm audio can be played in the background while recording speech content associated with a particular spread or page that depicts a scene with rain. In other embodiments, the themed music itself may be post-processed with the recorded UGC to generate final audio content containing both the UGC and the recorded theme as a back-drop.

Other embodiments of the present invention provide normalized user recorded audio and other dynamic post processing. The audio content of commercially available electronic publications may be professionally authored and produced (e.g., using a studio), to ensure that volume levels are normalized, e.g., adjusted, for a comfortable listening experience. Since UGC recordings are not produced professionally in this manner, embodiments of the present invention provide level normalization and other post processing effects. To normalize the recording, the volume of the recording may be adjusted, such as, for example, by increasing the volume beyond the maximum set for other applications and relaxing the speaker specification for maximum volume temporarily or for certain spreads/books. The user may also be given the option to add dynamic effects to his/or recording, such as bass, treble, reverb and/or virtual 3-D sound effects, to name a few.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates the initial user interface;

FIG. 2 illustrates an electronic publication open to the first spread with the read and record mode operational;

FIG. 3 illustrates the countdown screen for recording;

FIG. 4 depicts the save recording popup on the back cover page

FIG. 5 illustrates the name recording popup;

FIG. 6 depicts the photo selection popup;

FIG. 7 depicts the edit recording popup;

FIG. 8 depict the cover page containing selectable recordings;

FIG. 9 depicts the basic architecture of the socket implementation;

FIG. 10 is a flow chart for Android (Java) code;

FIG. 11 is a flow chart for Flash (AS3) code;

FIG. 12 illustrates an exemplary system according to the present invention; and

FIG. 13 illustrates the components of an exemplary device.

### DETAILED DESCRIPTION OF THE INVENTION

The present invention provides a Read and Record functionality that allows users to record their own UGC narration to accompany their electronic publications or other digital content. in a preferred embodiment, the Read and Record functionality for producing UGC audio corresponds to multi-page spreads, as opposed to block-by-block UGC narration. As appreciated by those skilled in the art, although the embodiments described herein are described with respect to electronic publications, the system and methods of the present invention are equally applicable to other digital and/or electronic content such as magazines and periodicals.

Referring now to FIG. 1, there is seen a UI 200 depicting the front page of an electronic publication. As shown in FIG. 1, UI 200 presents the user with three modes of operation with respect to a particular electronic publication: Read by Myself mode 210, Read to Me mode 220 and Read and Record mode 230. The user may select a mode by tapping, with respect to embodiments with touch screens, or by other suitable means. The Read by Myself mode 210 allows the user to read the electronic publication without invoking the audio playback features of the present invention. The Read and Record mode 230 allows the user to record audio that is associated with particular spreads or pages of the electronic publication. The Read to Me mode 220 allows the user to read the electronic publication accompanied by audio previously recorded via the Read and Record mode 230.

In one embodiment of the present invention, the Read and Record mode 230 is made available to the user if the publisher of the electronic publication authorized the recording of content. Preferably, metadata of the publication includes a “data flag” indicating whether authorization has been secured. This data flag, in turn, is used to determine whether to display and/or enable the Read and Record mode 230 and associated functionality.

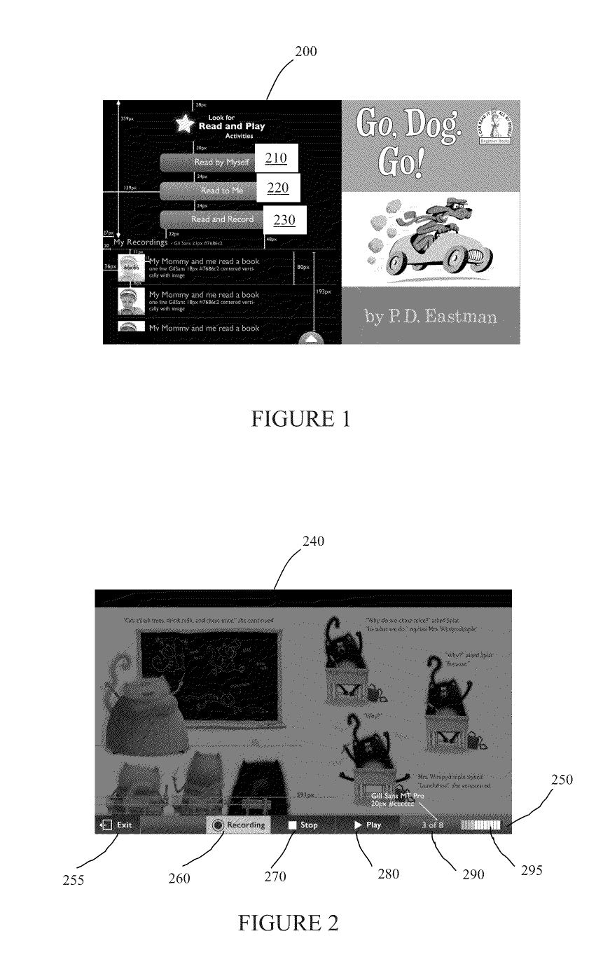

The Read and Record mode 130 invokes the UGC process of the present invention which, in turn, automatically invokes a recording mode. As illustrated in FIG. 2, entering the Read and Record mode 130 causes the electronic publication to open to the first spread 240 and display a recording toolbar and Heads Up Display (“HUD”) 250 at the bottom of the screen. HUD 250 includes a Record button 260, a Stop button 270, a Play button 280, a spread/page display 290, a live volume indicator 295 and an Exit button 255.

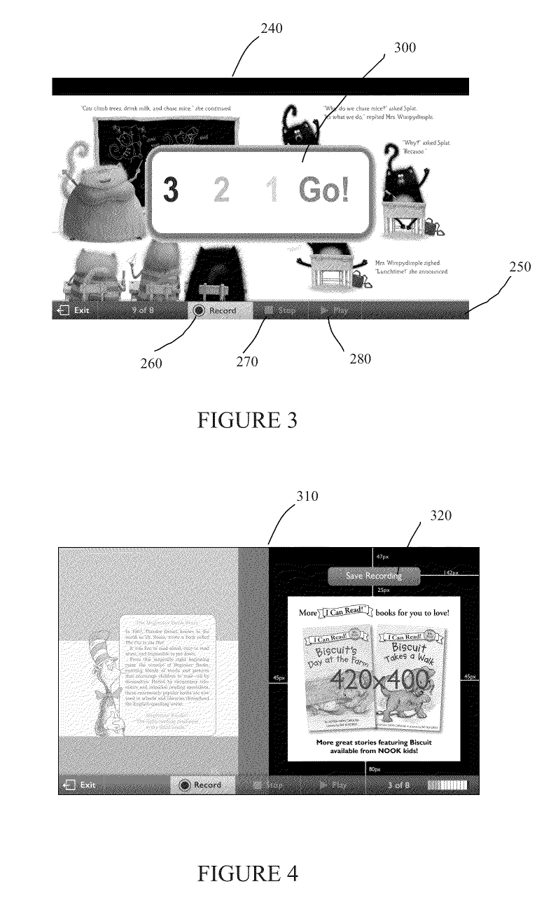

Recording of audio starts automatically after a three second animated countdown 300 (see FIG. 3) when a spread (e.g., spread 240) is changed or a page is turned, with HUD 250 opening automatically and Record button 260 blinking in a “Recording . . . ” state. In one embodiment, no recording is allowed on the book cover. While the audio is being recorded, the Stop button 270 is active and accessible, the Play button 280 is grayed out, and the live volume indicator 295 registers the volume level of input audio. The Stop button 270 permits the user to stop the recording. In another embodiment, recording also stops if the system on which the electronic publication is being viewed goes to sleep to save power, e.g., because of user inactivity over a period of time (e.g., five minutes), with the UGC recorded up to that point being saved and named automatically. The recording of audio content continues until the user has completed narration for spread 240. Automatically upon completion of the recording or upon activation of the Stop button 270, the Record button 260 becomes inactive and the Play button 280 becomes active to permit the user to playback the recording associated with the current spread or page 240. As the user turns to the next spread or page, recording continues automatically after the animated countdown 300.

If the user unintentionally exits the Read and Record mode 230 without manually saving the recording, e.g., due to loss of battery life, a crash of the application or timeout on inactivity, the system saves the last spread or page recorded and automatically generates a default name for the full recording: “My Recording [timestamp].” On returning to the electronic publication file, the user can view the partially completed recording in a My Recordings list, and can choose to continue recording by entering the edit-recording process.

Exit button 255 permits the user to exit the recording process, at which time the user is given the option of saving the recording, e.g., via a pop-up window. Spread/page display 290 displays the spread or page 240 currently accessed by the user, e.g., “3 of 8,” which varies from publication to publication. In one embodiment, the cover page is not included in this display because recording may be enabled only for interior spreads and pages. In another embodiment, the back cover is included in the spread count.

Preferably, the user can double-tap text on a spread to enlarge the text while recording audio. In a preferred embodiment, however, this data is not saved. Thus, on playback, the user would not see text boxes auto-enlarge. In another embodiment, certain activities and animation hotspots contained in the electronic publication, and their associated buttons, are not active and/or not displayed during recording.

In another embodiment of the present invention, the user is given the option to re-record audio for a particular spread and/or page 240 of the electronic publication after recording for the spread and/or page 240 has stopped. To re-record, the user re-taps the Record button 260. This causes a popup window (not shown in Figures) to be displayed with the following options: “Re-record this page? [Cancel].” If the user chooses “Re-record,” the system erases the existing recording and re-starts the recording process as described above. If the user chooses “Cancel,” the popup window is closed.

Once a user has stopped a recording for a spread or page 240, the user has the option to play back the recording for that spread or page 240. Tapping the Play button 280 causes the button to change to a “Pause” state, while the system plays back the recording for the current spread or page 240. Tapping Play button 280 again while in the “Pause” state pauses the playback and reverts button 280 back to the Play state. Tapping button 280 yet again causes the system to resume playback.

As shown in FIG. 4, when user finishes recording audio content for each spread or page 240 and arrives at the Back Cover 310, the user is given the option of tapping the “Save Recording” button 320 to exit the recording process and save the recording for the electronic publication.

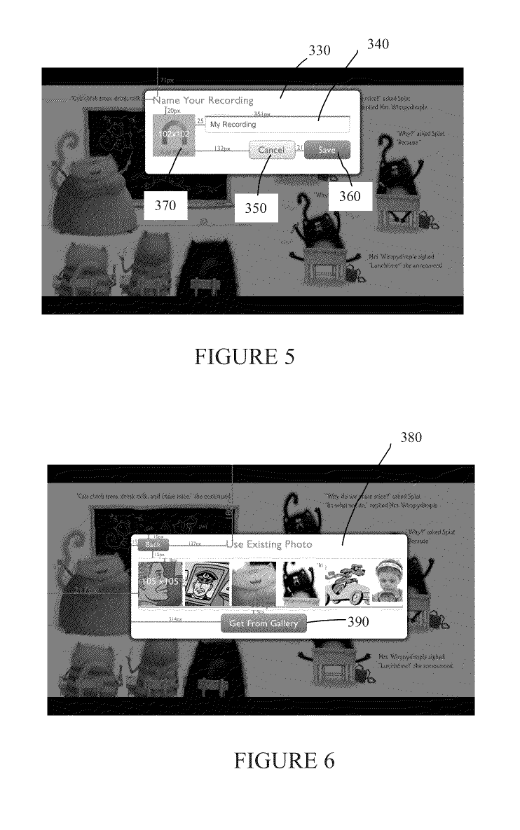

If the user exits an audio recording by tapping the Exit button 255 during recording or the Save Recording button 320 on the back cover page 310, the system displays the Name Recording popup window 330 as illustrated in FIG. 5. The Name Recording popup window 330 includes a text field 340, a Save button 360, a Cancel button 350 and an “add photo” area 370 associated with the recording. In a preferred embodiment employing a touch screen, the user taps the text field 340 to display a keyboard, which the user may employ to designate a name for the recording. After the name is designated, the user can tap the Save button 360 to save the name and recording. After the recording is saved, the recording appears in the user's “My Recordings” menu on the front cover UI screen 200 (See FIG. 1). If the user taps the Save button 360 without first designating a name, the system saves the recording as “My Recording [timestamp],” in the time format X:XX PM/AM, e g “2:25 pm,” To cancel saving the recording and continue the recording process, the user taps the “Cancel” button 350. The user may also delete a previously recorded audio file by tapping a “Delete” button (not shown in FIG. 5). If a file is selected for deletion, an error message is preferably displayed to the user, e.g., “Are you sure you want to delete this recording?”

To assign an image, photo or avatar to the recording, the user can tap the “add photo” area 370. In one embodiment, as shown in FIG. 6, the virtual keyboard closes and an image selection popup window 380 displays a horizontally scrollable series of pre-installed avatars/images. The user can scroll the horizontal display of existing images/photos/avatars and tap to select an existing image, or may tap the “Get From Gallery” button 390 to access additional images from one or more galleries. When an image is selected, the image selection popup window 380 is closed, and the user is returned to the Name Recording popup window 330, where the selected image (or a default image if none is selected) is displayed alongside the name of the recording. In another embodiment, social media profile images may be retrieved and used. Tapping the Save button 360 at this point will save the image, as well as the recording and name assigned thereto.

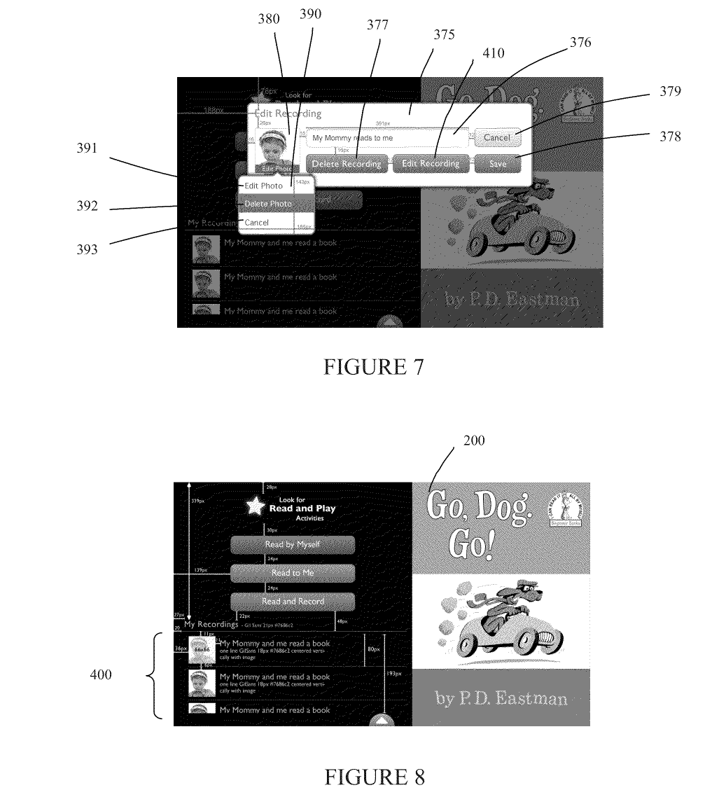

In one embodiment of the present invention, as illustrated in FIG. 7, a recording previously saved by a user may be edited or deleted via an Edit Recording popup window 375. Edit Recording popup window 375 includes a text area 376 for changing the name of a recording, a Delete Recording button 377 for deleting a recording, an Edit Recording button 410 for editing a recording, a Save button 378 for saving an edited recording, and a cancel button 379 for canceling the editing process and closing Edit Recording popup window 375. To edit the recording for a particular electronic publication, the user taps the “Edit Recording” button 410 to open the spreads and/or pages of the publication in recording mode. If a particular spread or page is already associated with recorded audio content, auto-recording (see above) does not launch, but rather, the user is prompted with a “Re-record” button (not shown) that permits the user to re-record the audio content for that spread or page. If a particular spread or page is not associated with audio content, the user can tap the “Record” button 260 (see FIG. 2) to enter recording mode to record new content. While in recording mode, auto-recording launches with respect to any spread or page with no recorded audio content.

Once the user is done editing the recording, he/she may save the recording by tapping the Save Button 378 on Edit Recording popup window 375, the Exit button 255 in HUD 250 (see FIG. 2) or the Save Recording button 320 on back cover screen 310 (see FIG. 4). The process for saving the recording is the same as that described above with respect to FIGS. 2-6.

In another embodiment, Edit Recording popup window 375 is also provided with a pull-down menu 390 for editing or deleting an image/photo/avatar 380 associated with the recording. To achieve this, the user taps the image/photo/avatar 380 to open pull-down menu 390 with “edit photo” 391, “delete photo” 392, and “cancel” 393 options. Tapping the “edit photo” option 391 allows the user to edit the selected image/photo/avatar 380. Tapping the “delete photo” option 392 removes image/photo/avatar 380, displays a default photo or image (e.g., a default avatar), and prompts the user, via an “Add Photo” prompt (not shown), to select a different photo or image. If the user does not select a new image, the default photo or image remains saved with the recording. Tapping “Cancel” option 393 closes pull-down menu 390 and cancels any unsaved changes.

When the user starts to record audio content for the first spread or page of an electronic publication, the system automatically generates a file associated with the publication and assigns it a name. Subsequent recordings for other spreads or pages of the publication are automatically saved on a page turn, preferably, to an individual file that is compressed and encoded. Preferably, several formats for recording audio are made available, with the format for a particular recording being chosen in accordance with the operating system on which the recording is made. In accordance with one embodiment, the format of the audio recording can be converted to another format to permit the audio to be played back on a different computer platform. In another embodiment, the audio recordings are saved as a ZIP file on a memory in the device on which the recording is made. It should be appreciated that other file formats may be used besides a ZIP format, and that the audio recordings may be saved to a memory external to the device on which the recording is made.

In one embodiment of the present invention, the system determines an average amount of memory required for audio content at the start of recording. If that amount of memory is not available on the device, the user is notified “not enough memory.” If the device is close to running out of memory before the user finishes and saves the audio content, the system stops recording, saves the current spread or page, and displays an error message, e.g., “System is out of memory. Please insert SD card or delete unwanted files to free up memory, Your in-progress recording has been saved up to this point. You can go back and edit once you free up memory.”

In another embodiment of an electronic publication containing numerous spreads, e.g., 40 spreads, a user can record for a maximum amount of time per spread, e.g., five minutes. Assuming an electronic publication of 40 spreads at 5 minutes per spread recording time, the maximum number of minutes required to record audio content for the publication would be: 5 min.×40 spreads=200 minutes. In this embodiment, the user is permitted to record up to 10 versions of the electronic publication. If the user already has 10 recordings for an electronic publication and taps the “Read and Record” button 230 (see FIG. 1), an error message is displayed, e.g., “You may create only 10 recordings per book. To make a new recording, first delete one below by touching and holding the recording name to edit, then tapping Delete.” As appreciated, the limits on recording sizes and numbers of versions are imposed by the device on which the recordings are made and may vary accordingly.

Referring now to FIG. 8, there is seen front cover UI 200 with a “My Recordings” scrollable list 400 displaying previously recorded and saved audio content associated with one or more electronic publications available for playback. If no recordings exist, My Recordings list 400 does not display. The display of each recording in list 400 includes an image/photo/avatar (either default or selected by the user), the user-supplied name of the recording, and a recording date (defined as the date the recording was created or last edited). With respect to embodiments employing a touch screen, the user can swipe My Recordings scrollable list 400 vertically to scroll through saved recordings for selection. To initiate playback of a particular electronic publication, the user taps on the image or recording name of the publication. This displays cover page 200 and begins audio playback of the recorded audio content associated with the electronic publication.

When a user selects a particular recording to playback from My Recordings scrollable list 400, the electronic publication opens and audio playback begins with the first spread or page. Changing the spread or turning the page interrupts playback, if in progress, and starts playback of the audio content associated with the next spread or page. While the audio content is being played back, text enlargement functions are enabled and can be invoked by double-tapping on selected text for enlargement. User triggered animations and other activities not available during recording are also enabled during playback. If an activity is present for a spread or page (as denoted, for example, via an icon), tapping the icon stops playback of the audio and starts the activity. In one embodiment, the UGC audio does not automatically resume when the activity is ended, but, rather begins with the next spread or page when the spread is changed or the page is turned.

In a preferred embodiment, all UGC audio files for a particular electronic publication are saved internally, not on an SD card, to an appropriate folder on the device (e.g., My files>My Recordings>) linked to the publication (e.g., by name). This way, the audio files are matched with the publication when it is opened. In another embodiment, the recordings are saved on a per spread or per page basis and not as one monolithic file associated with the electronic publication. This may be accomplished, for example, by creating folders with individual data files describing recording name, associated photo, date, time, etc. The format of the audio files can be AAC or mp3 or other formats, and may or may not be encrypted. The audio files may also be synced with and pushed to other devices (including those without microphones) via the cloud or other suitable means.

Since the files are saved within the device, any edits to or deletions of files are preferably performed within the device itself, In other embodiments, files may also be edited or deleted using another mechanism external to the device, such as a personal computer connected to the device via suitable means.

Since the audio files associated with the electronic publication are saved on a spread-by-spread basis and are meant to accompany the publication when read, it may not be desirable for these files to be accessible by an audio music player application on the device. For this reason, in accordance with one embodiment of the present invention, the audio files associated with the electronic publication are saved in such a manner so as to be inaccessible or not detectable by other applications, such as audio music players.

In a preferred embodiment, the playback and recording application of the present invention is designed as a native Adobe Flash™ application for execution on the Android™ operating system, which is employed in many of today's smart phones and tablet computers. To design a Flash™ application for Android™ (such as a Flash™ version of the playback and recording application described herein), application designers typically use the Adobe™ Integrated Runtime environment (“AIR”), which is a cross-platform runtime environment for building Rich Internet Applications (RIA) using various programming languages, such as Flash™. In one embodiment of the present invention, the Flash™ version of the playback and recording application is designed as a native Android™ application for execution within a native Java™ wrapper.

However, since Flash™ does not provide native codecs for audio files, Flash™ and AIR™ are not particularly well suited for processing audio information in their native environments, especially when cross-platform compatibility is desired. In fact, Flash™ did not even have the ability to capture audio data from a microphone until Flash Player™ version 10, Available third-party Flash™ codecs are available, but they work only with WAV or Ogg Vorbis files and, in any event, are resource intensive and slow.

In contrast to Flash™, the Android™ operating system is well suited to process audio information in its native environment. AIR, however, does not provide the ability to design Flash™ applications that can access resources of the Android™ operating system. Indeed, as of AIR version 2.6, programmers could not access any native Android™ code (such as background processes, naïve constants and properties) from the ActionScript used to create Flash™ applications. AIR version 3.0 provides some native Android™ Extensions, but is still unsuited for creating Flash™ applications with adequate audio processing capabilities. This is a huge problem.

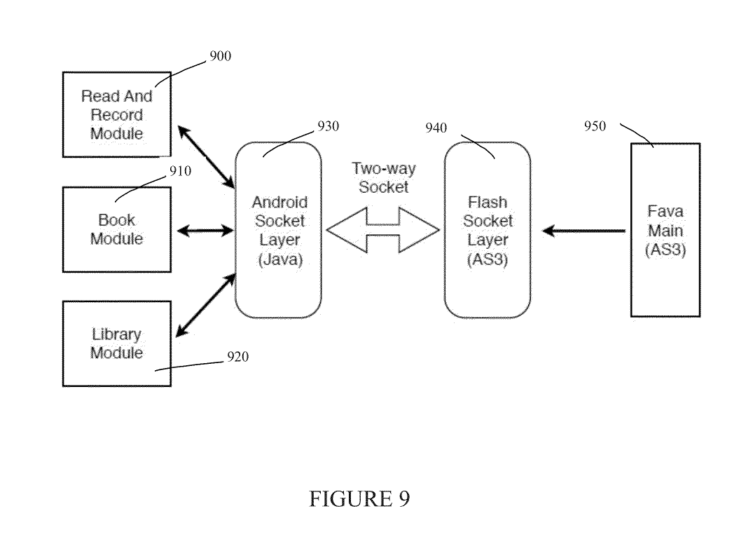

As illustrated in FIG. 9, embodiments of the present invention address this problem by creating a “tunnel” from the Flash™ application to the Android™ operating system, such that the playback and recording application can access resources of and send “commands” to the operating system. To achieve this, the playback and recording Flash™ application 950 uses open Java™ sockets 930, 940 to send established commands like “startRecording” and “stopRecording” to a listening Java™ class 900, 910, 920. The listening Java™ class 900, 910, 920 can parse these commands, execute them, and send messages hack to the playback and recording Flash™ application 950. In this way, the present invention can off-load the entire recording process to the Android™ operating system.

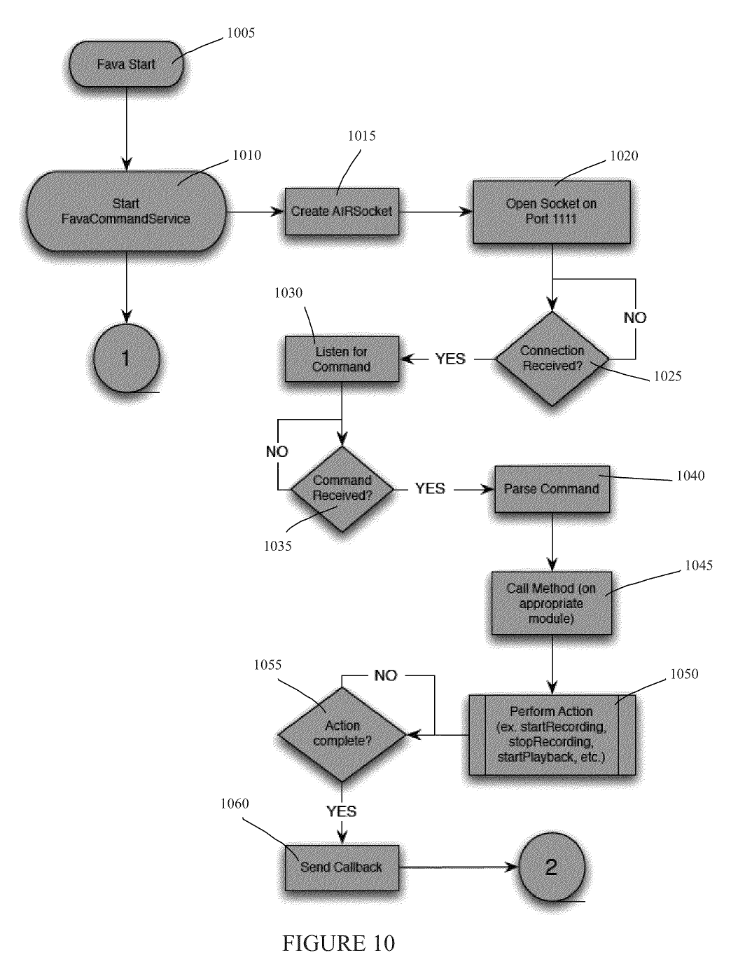

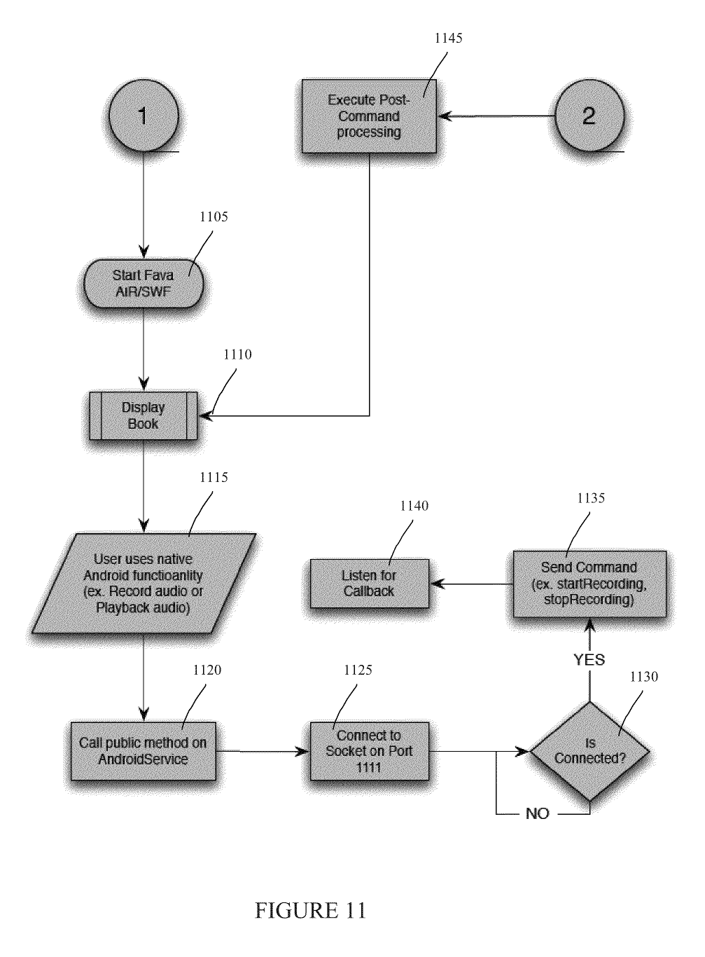

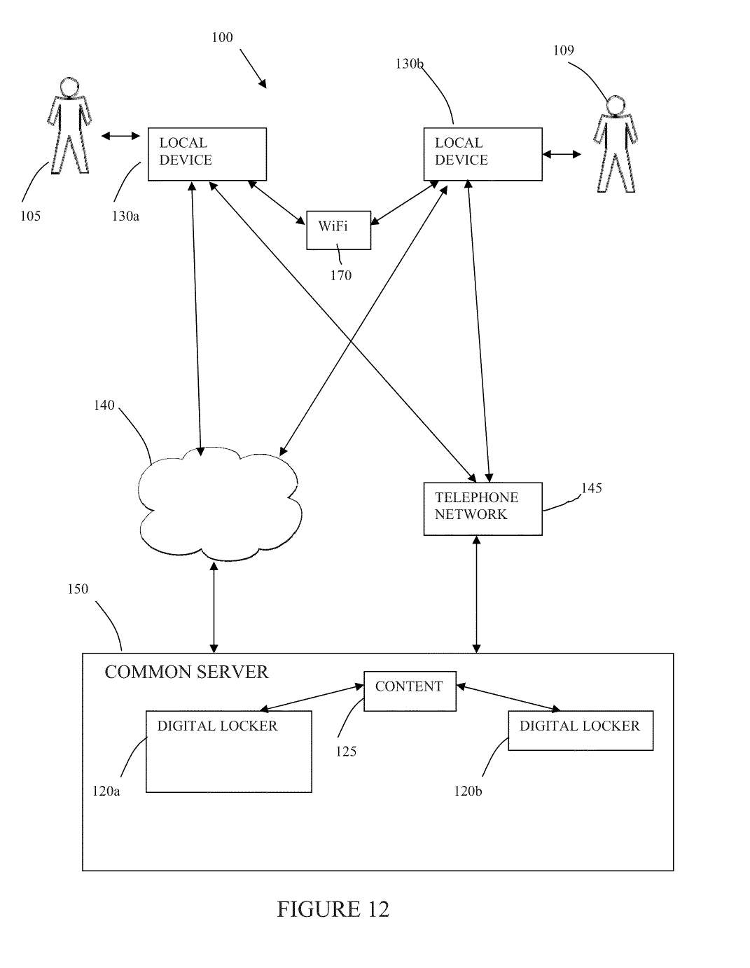

To create the tunnel to the Android operating system, both Java™ and Flash™ subroutines are required. Referring now to FIG. 10, there is seen a flowchart of Android (Java™) code for creating the tunnel to the Android operating system and executing commands therewith. The process starts at step 1005 and proceeds to step 1010 where the Java Command Service is initiated. Next, an AIR socket is opened on port 1111 at steps 1015 and 1020. After the socket is opened, the process checks whether a connection has been received at step 1025. If a connection is received, the process proceeds to step 1030 to listen for a command from the Flash™ application. If a command is received at step 1035, the process proceeds to step 1040, at which point the command is parsed. The process then proceeds to step 1045 to invoke the appropriate command module and, in step 1050, to perform the action requested by the command (e.g., start recording, stop recording, start playback, etc.). The process then proceeds to step 1055. Once the requested action completes, the process proceeds to step 1060, at which point a callback message is sent to the Flash™ application. Post command processing is performed at step 1145 (see FIG. 11) and the process proceeds to step 1110 (see FIG. 11).

Referring now to FIG. 11, there is seen a flowchart of Flash™ (AS3) code for creating a tunnel to the Android operating system and executing commands therewith. The process begins at step 1105 and proceeds to step 1110 where the electronic publication is displayed to the user. At step 1115, the user invokes an audio function (e.g., record, playback, etc.). This causes the Flash™ playback and recording application to call a public method on the Android™ service at step 1120 and to connect to the Java Socket on port 1111 at step 1125. Once a connection to the socket is confirmed at step 1130, the process proceeds to step 1135 where the particular command is sent (e.g., record, playback, etc.). The process then ends at step 1140 once a callback message is received.

FIG. 12 shows components of a system that can employ to the present invention. User 105 is an authorized user of system 100 and uses her local device 130a for the reading of digital content and interacting with other users, such as user 109. Many of the functions of system 100 are carried out on server 150. As appreciated by those skilled in the art, many of the functions described herein can be divided between the server 150 and the user's local devices 130a-130b. Further, as also appreciated by those skilled in the art, server 150 can be considered a “cloud” with respect to the users and their local devices 130a, 130b. The cloud 150 can actually be comprised of several servers performing interconnected and distributed functions. For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's 105 digital locker 120a located on the server 150. As further described below, in the preferred embodiment of the present invention, digital locker 120a contains links to copies of digital content 125 previously purchased (or otherwise legally acquired) by user 105.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the users 105, 109 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the lending server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list. In a preferred embodiment, the user's contact list will also indicate if the contact is also an authorized (registered) user of the system 100 with his or her own account on server 150.

User 105 can access his or her digital locker 120a using a local device 130a. Local device 130a is an electronic device such as a personal computer, an e-book reader, a smart phone or other electronic device that the user 105 can use to access the server 150. In a preferred embodiment, the local device has been previously associated, registered, with the user's 105 account using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read the book, listen to the music or watch the video.

In a preferred embodiment, local device 130a includes a non-browser based device interface that allows user 105 to initiate the discussion functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with lending server 150, which authorizes user 109 to use system 100. As appreciated by those skilled in the art, the number of users 105, 109 that employ the present invention at the same time is only limited by the scalability of server 150. As with user 105, user 109 can access his or her digital locker 120b using her local device 130b. In a preferred embodiment, local device 130b is a device that user 109 has previously associated, registered, with his or her account using user's 109 account credentials. Local device 130b allows user 109 to download copies of his digital content 125 from digital locker 120b. User 109 can engage with downloaded digital content 125 locally on local device 130b.

Devices 130a and 130b can further be connected via WiFi AP 170.

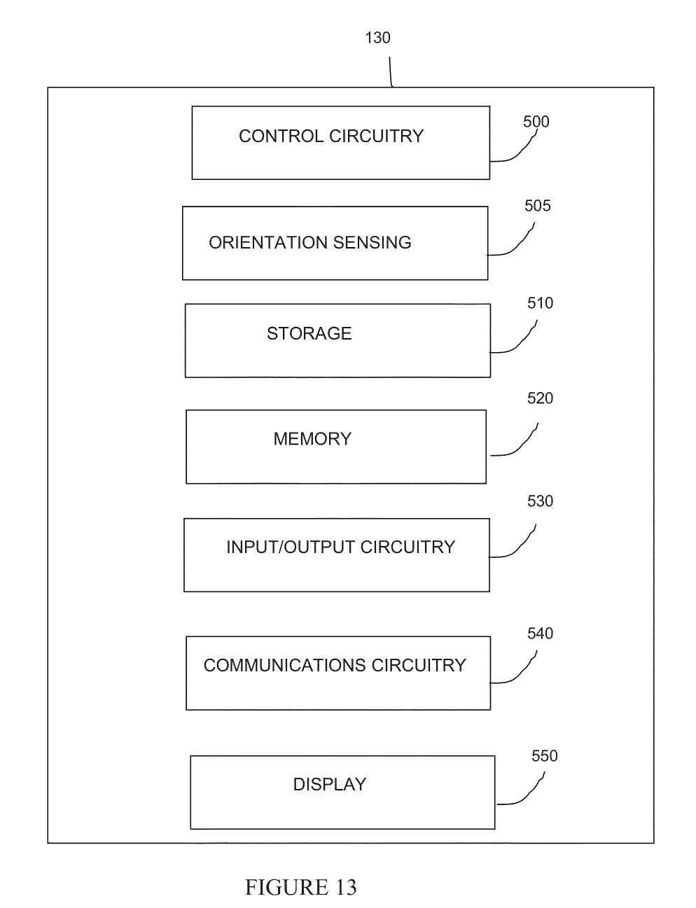

FIG. 13 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in FIG. 13, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUT), which drives the display 550 to present the GUI for the desired mode.

Storage 530 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 530.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 13 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media data into analog signals. For example, the display circuitry or other appropriate circuitry within electronic device 130 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, WiFi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in FIG. 13 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art, it is preferred, therefore, that the present invention be limited not by the specific disclosure herein, but only by the gist and scope of the disclosure.

What is claimed is

1. A method for recording and playing back audio in association with an electronic publication that is viewed on an electronic device running an operating system, the method comprising:
executing a user interface application on the electronic device for viewing the electronic publication and invoking audio functions for recording and playing audio in association with the electronic publication;
establishing a socket between the user interface application and the operating system;
transmitting an audio command from the user interface application to the operating system through the socket;
executing the audio command by the operating system using native operating system commands; and
transmitting a message regarding the execution of the audio command from the operating system to the user interface application.

2. The method according to claim 1, wherein the user interface application is a Flash application and the operating system is Android.

3. A non-transitory computer-readable media comprising a plurality of instructions that, when executed by at least one electronic device, cause the at least one electronic device to:
execute a user interface application on the electronic device for viewing the electronic publication and invoking audio functions for recording and playing audio in association with the electronic publication;
establish a socket between the user interface application and the operating system;
transmit an audio command from the user interface application to the operating system through the socket;
execute the audio command by the operating system using native operating system commands; and
transmit a message regarding the execution of the audio command from the operating system to the user interface application.

4. The non-transitory computer-readable media according to claim 3, wherein the user interface application is a Flash application and the operating system is Android.

5. A system for controlling an electronic device comprising:
a memory that includes instructions for operating the electronic device, an operating system and an electronic publication;
a display screen; and
control circuitry coupled to the memory, coupled to the input surface, coupled to the sensors and coupled to the display screen, the control circuitry executing the instructions and is operable to:
execute a user interface application on the electronic device for viewing the electronic publication and invoking audio functions for recording and playing audio in association with the electronic publication;
establish a socket between the user interface application and the operating system;
transmit an audio command from the user interface application to the operating system through the socket;
execute the audio command by the operating system using native operating system commands; and
transmit a message regarding the execution of the audio command from the operating system to the user interface application.

6. The system according to claim 5, wherein the user interface application is a Flash application and the operating system is Android.
